(19) United States
(12) Patent Application Publication
(10) Pub. No.: US 2015/0291137 A1
(43) Pub. Date: Oct. 15, 2015

(54) BRAKING DEVICE FOR VEHICLE DESIGNED TO ACHIEVE SMOOTH DECELERATION

(71) Applicants: DENSO CORPORATION, Kariya-city (JP); Advics Co., Ltd., Kariya-city (JP)

(72) Inventors: KIYOHITO TAKEUCHI, Kariya-shi (JP); KAZUYA MORISHITA, Obu-shi (JP)

(21) Appl. No.: 14/682,571

(22) Filed: Apr. 9, 2015

(30) Foreign Application Priority Data
Apr. 11, 2014 (JP) 2014-081903

(51) Int. Cl. B60T 8/172; B60T 8/34

(52) U.S. Cl. CPC B60T 8/172; B60T 8/34

(57) ABSTRACT

A brake device for a vehicle is equipped with an electric motor which drives a pump to deliver brake fluid to a wheel cylinder installed in a wheel of the vehicle. The brake device works to control pressure of the brake fluid in the wheel cylinder for creating a target braking force. In response to an increase in stroke of a brake pedal, the brake device elevates the pressure in the wheel cylinder gradually without sharply changing it. This eliminates deterioration of a driver's braking feeling arising from a variation in deceleration of the vehicle and ensures smooth deceleration of the vehicle intended by the driver of the vehicle.

### CROSS REFERENCE TO RELATED DOCUMENT

The present application claims the benefit of priority of Japanese Patent Application No. 2014-81903 filed on Apr. 11, 2014, the disclosure of which is incorporated herein by reference.

### BACKGROUND OF THE INVENTION

1 Technical Field of the Invention

This disclosure relates generally to a brake system for vehicles which works to produce a braking force with the aid of a pump driven by an electric motor in response to an amount by which a brake actuating member is manipulated.

2 Background Art

Japanese Patent First Publication No. 2013-6529 teaches a brake system for an automotive vehicle which is engineered to actuate an electric motor to drive a pump for controlling a brake installed in the vehicle.

The brake system is equipped with a differential pressure control valve disposed in a pipe connecting between a master cylinder (also referred to as an M/C below) and a wheel cylinder (also referred to as a W/C below) to control a pressure difference between the master cylinder and the wheel cylinder. The brake system also includes a pump and an electric motor. When the differential pressure control valve is placed in a pressure differential mode, the electric motor drives the pump to suck brake fluid from the master cylinder and discharge it to the wheel cylinder to develop hydraulic pressure in the wheel cylinder (also referred to as wheel cylinder pressure below). To create a degree of braking force required as a function of a manipulated variable representing an amount by which the brake is manipulated, the brake system calculates a target speed of rotation of the motor as a function of the required degree of braking force and drives the motor at the target speed to operate the pump.

Specifically, the target speed of the motor for creating the required degree of braking force is determined by calculating a flow rate of the brake fluid discharged from the pump as a function of a change in wheel cylinder pressure that is a controlled hydraulic pressure and deriving the target speed as a function of the flow rate of the brake fluid.

The differential pressure control valve is a linear control valve. The pressure difference, as developed by a pressure relief operation of the differential pressure control valve, is regulated as a function of the quantity of electricity supplied to the differential pressure control valve (i.e., a solenoid). However, the activation of the electric motor at a speed required to bring the pressure difference to be developed by the differential pressure control valve into agreement with a target value may result in a difference between the target value and an actual value of the pressure difference. This is because an increase in discharged flow rate of the pump will result in a restricted flow rate of the brake fluid passing through the differential pressure control valve, which leads to a lack in flow rate of the brake fluid outputted from the differential pressure control valve. Such a difference between an expected flow rate and an actual flow rate of the brake fluid discharged from the differential pressure control valve is usually referred to as a pressure loss which, as demonstrated in FIG. 5, depends upon the speed of the electric motor.

Therefore, the brake system, as taught in the above publication, is designed to subtract the pressure loss depending upon the speed of the electric motor from a target pressure difference required for the differential pressure control valve to be developed to calculate a target quantity of electricity to be supplied to the differential pressure control valve. Specifically, the brake system substrates a required flow rate of the brake fluid to be discharged from the pump from an actually discharged flow rate thereof to calculate a flow rate of the brake fluid passing through the differential pressure control valve and determines the quantity of current to be supplied to the differential pressure control valve as a function of the calculated flow rate of the brake fluid.

When the speed of the electric motor has increased after being decreased or vice versa, the pressure loss will change in the same way. The target pressure difference is, therefore, achieved by increasing or decreasing the quantity of current to be supplied to the differential pressure control valve. There is, however, a hysteresis, as illustrated in FIG. 6, between when the pressure difference is being increased by increasing the quantity of current to be supplied to the differential pressure control valve and when the pressure difference is being decreased by decreasing the quantity of current to be supplied to the differential pressure control valve. This results in a response lag between when the differential pressure changes from increasing to decreasing or increasing to decreasing. When the ratio of the pressure loss to a required pressure difference is great, for example, in a low-deceleration range, it may result in a failure in achieving the required pressure difference due to the response lag arising from the hysteresis. It may be difficult to give the driver of the vehicle a good braking feeling, particularly, when the driver actuates the brake gently.

Specifically, the above brake system calculates the target speed of the motor only based on the relation between the target pressure of controlled pressure (i.e., the W/C pressure) and the volume of brake fluid required by a brake caliper to achieve the target pressure. This will result in a sharp change in speed of the motor in response to a change in stroke of the brake pedal (which will also be referred to as a pedal stroke below), which leads to the pressure loss, as described above. The pressure loss results in a rapid change in flow rate of the brake fluid discharged from the pump, thereby causing the degree of deceleration of the vehicle to vary, giving the driver a feeling of discomfort. This phenomenon will be described in detail with reference to FIGS. 7(a) to 7(f) below.

Usually, brake systems for automotive vehicles are engineered to aim at achieving a characteristic, as demonstrated in FIG. 7(a), in which the target pressure Pt [MPa] of the controlled pressure (i.e., the W/C pressure) of the brake fluid rises gradually with an increase in the pedal stroke S [m]. The rate of rise in the target pressure Pt is selected so as to increase with an increase in the pedal stroke S.

The relation between the target pressure Pt of the controlled pressure and the volume V[m³] of brake fluid required by the brake caliper (i.e., the wheel cylinder) to achieve the target pressure Pt depends upon design specifications of the brake caliper. Specifically, the volume V of the brake fluid increases at a first rate until the target pressure Pt reaches a given level Pa. When the target pressure Pt exceeds the given level Pa, the volume V of the brake fluid increases at a second rate smaller than the first rate.

From the relations in FIGS. 7(a) and 7(b), a characteristic, as indicated by a broken line in FIG. 7(c), is derived which represents a volume-to-braking relation of the volume V of the brake fluid to the pedal stroke S. The characteristic in FIG. 7(c) depends directly on the relations in FIGS. 7(a) and 7(b) and may be determined simply as representing the relation of the volume V of the brake fluid to the pedal stroke S. The relation has a range, as enclosed by a broken line in FIG. 7(c), in which the volume V of the brake fluid changes sharply in response to an increase in the pedal stroke S. The volume D [m³/sec.] that is the volume of the brake fluid discharged from the pump per unit time is directly proportional to the speed R [rpm] of the motor.

By converting the relation between the pedal stroke S and the volume V of the brake fluid in FIG. 7(c) into the relation between the pedal stroke S and the speed R [rpm] of the motor using the relation, as illustrated in FIG. 7(d), between the volume D [m³/sec.] of the brake fluid per unit time and the speed R of the motor, we obtain a characteristic, as indicated by a broken line in FIG. 7(e). Specifically, between S₀ to SA of the pedal stroke S in FIG. 7(c), the volume V increases at a first rate (i.e., a lower rate), so that the motor speed R is kept at RA. Subsequently, between SA and SB of the pedal stroke S, the volume V increases greatly at a second rate (i.e., a higher rate), so that the motor speed R is kept at RB (>RA). Afterwards, when the pedal stroke S exceeds SB, the volume V increases gradually again at a third rate (i.e., a lower rate), so that the motor speed R is kept at RC.

The motor speed R, as described above, increases sharply between SA and SB of the pedal stroke S. This causes, as indicated by a broken line in FIG. 7(f), the controlled pressure P (i.e., the W/C pressure) of the brake fluid to have a portion changing greatly due to the pressure loss depending on the motor speed R and the hysteresis of the differential pressure control valve, so that the controlled pressure P does not follow the desired braking characteristic indicated by a broken line in FIG. 7(f) which is the same as in FIG. 7(a). This makes the driver feel uncomfortable. Basically, the technique of determining the volume V of the brake fluid required to develop the controlled pressure corresponding to the pedal stroke S and calculating the speed of the motor required to achieve the volume V results in a difficulty in ensuring the comfort of the braking operation.

### SUMMARY

It is therefore an object of this disclosure to provide a brake device for a vehicle which is engineered to eliminate an undesirable sharp change in speed of an electric motor in response to a change in operation of a brake to ensure smooth deceleration of the vehicle, thereby achieving a good braking feeling.

According to one aspect of the invention, there is provided a brake device for a vehicle which comprises: (a) a brake manipulated variable determiner which determines a brake manipulated variable representing a degree to which a brake actuating member is manipulated by an operator of a vehicle; (b) a master cylinder which works to develop a master cylinder pressure of brake fluid as a function of the brake manipulated variable; (c) a wheel cylinder in which a wheel cylinder pressure of the brake fluid is developed as a function of the master cylinder pressure to create a braking force exerted on a wheel of the vehicle; (d) a differential pressure control valve which is disposed in a main hydraulic path extending between the master cylinder and the wheel cylinder and works to create a pressure difference of the brake fluid between the master cylinder pressure and the wheel cylinder pressure; (e) a pump which works to discharge the brake fluid to a portion of the main hydraulic path between the differential pressure control valve and the wheel cylinder to elevate the wheel cylinder pressure; (f) a motor which drives the pump; and (g) a controller which outputs a pressure-difference control signal to place the differential pressure control valve in a pressure-differential mode to develop said pressure difference. The controller also actuates the motor to drive the pump to elevate the wheel cylinder pressure to create the braking force as a function of the brake manipulated variable.

The controller includes a relation determiner, a target pressure determiner, a fluid volume determiner, and a target speed determiner. The relation determiner works to provide a pressure-to-braking relation between a target pressure of the wheel cylinder pressure and the brake manipulated variable and a volume-to-pressure relation between the target pressure of the wheel cylinder pressure and a volume of the brake fluid required by the wheel cylinder to achieve the target pressure of the wheel cylinder pressure.

The pressure-to-braking relation represents the target pressure of the wheel cylinder which rises at a given rate which increases with an increase in the brake manipulated variable. The volume-to-pressure relation is derived based on a volume-to-braking relation between the volume of the brake fluid and the brake manipulated variable. The volume-to-braking relation represents the volume of the brake fluid which increases continuously with an increase in the brake manipulated variable.

The target pressure determiner works to determine a target pressure of the wheel cylinder pressure as a function of the brake manipulated variable, as determined by the brake manipulated variable determiner, using the pressure-to-braking relation. The fluid volume determiner determines a target volume of the brake fluid as a function of the target pressure, as determined by the target pressure determiner, using the volume-to-pressure relation. The target speed determiner works to determine a target speed of the motor required to achieve the target volume of the brake fluid. The controller actuating the motor at the target speed to achieve the target pressure of the wheel cylinder pressure.

Specifically, the brake device serves to control the wheel cylinder pressure so as to rise gradually without sharply changing it with an increase in the brake manipulated variable. This eliminates deterioration of a driver's braking feeling arising from a variation in deceleration of the vehicle and ensures smooth deceleration of the vehicle intended by the driver.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a circuit diagram which illustrates a brake device according to an embodiment;

FIG. 2(a) is a view which represents a characteristic of a relation between a pedal stroke and a target pressure of brake fluid;

FIG. 2(b) is a view which represents a characteristic of a relation between a target pressure of brake fluid and volume of the brake fluid required to achieve the target pressure;

FIG. 2(c) is a view which represents a characteristic of a relation between volume of brake fluid required to achieve a target pressure and a pedal stroke;

FIG. 2(d) is a view which represents a characteristic of a relation between volume of brake fluid discharged per unit time from a pump and speed of a motor for driving the pump;

FIG. 2(e) is a view which represents a characteristic of a relation between pedal stroke and speed of an electric motor for a pump;

FIG. 2(f) is a view which represents a characteristic of a relation between pedal stroke and a target pressure of controlled pressure of brake fluid;

FIG. 3 is a view which represents a characteristic of a relation between volume of brake fluid required to achieve a target pressure and a pedal stroke in a first modification of an embodiment;

FIG. 4 is a view which represents a characteristic of a relation between volume of brake fluid required to achieve a target pressure and a pedal stroke in a second modification of an embodiment;

FIG. 5 is a view which represents a characteristic of a relation between speed of an electric motor for a pump and a pressure loss of brake fluid;

FIG. 6 is a view which demonstrates a change in electric current supplied to a differential pressure control valve and a resultant change in pressure difference developed by the differential pressure control valve;

FIG. 7(a) is a view which represents a characteristic of a relation between a pedal stroke and a target pressure of brake fluid;

FIG. 7(b) is a view which represents a characteristic of a relation between a target pressure of brake fluid and volume of the brake fluid required to achieve the target pressure;

FIG. 7(c) is a view which represents a characteristic of a relation between pedal stroke and volume of brake fluid required to achieve a target pressure of the brake fluid;

FIG. 7(d) is a view which represents a characteristic of a relation between volume of brake fluid discharged per unit time from a pump and speed of a motor for driving the pump;

FIG. 7(e) is a view which represents a characteristic of a relation between pedal stroke and speed of an electric motor for a pump; and

FIG. 7(f) is a view which represents a characteristic of a relation between pedal stroke and a target pressure of controlled pressure of brake fluid.

### DESCRIPTION OF THE PREFERRED EMBODIMENTS

Embodiments will be described below with reference to the drawings wherein like reference numbers refer to like or equivalent parts in several views.

### First Embodiment

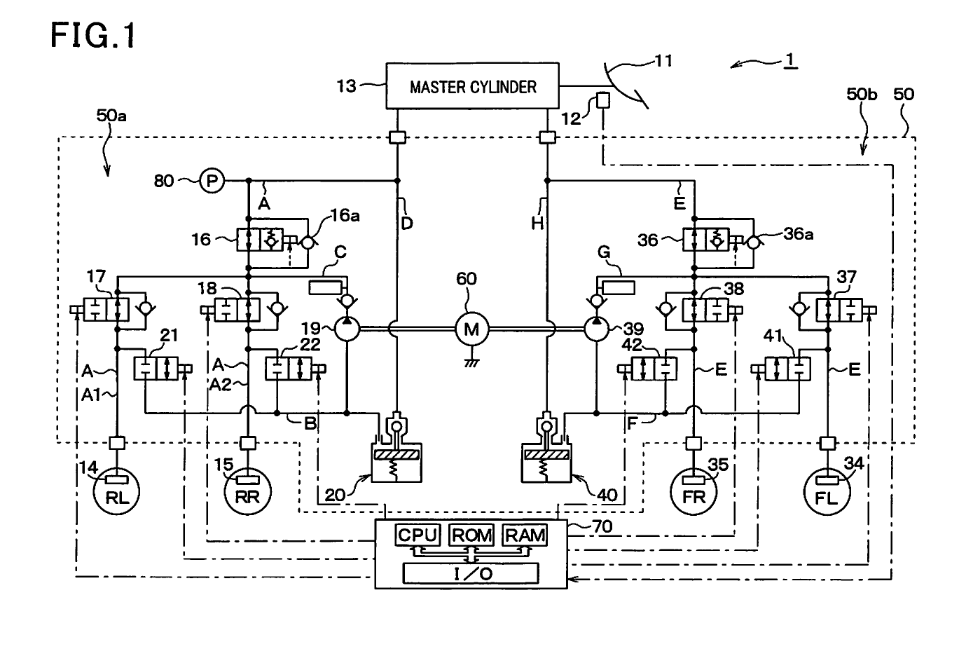

Referring to FIG. 1, there is shown a brake system equipped according to the first embodiment of the invention. The brake system, as referred to herein, is used with an automotive vehicle equipped with a so-called front/rear split hydraulic system, but may be employed with a diagonal split hydraulic system which includes two brake hydraulic circuits one of which controls the right front and the left rear wheel and the other of which controls the left front and the right rear wheel.

The brake system includes a brake device 1 which is equipped with a brake pedal 11 (i.e., a brake actuating member) to be depressed by a vehicle occupant or driver for applying the brakes to the vehicle, a stroke sensor 12, a master cylinder 13, wheel cylinders 14, 15, 34, and 35, and a brake pressure control actuator 50. When the driver depresses the brake pedal 11, the stroke sensor 12 works as a brake manipulated variable determiner to detect a degree to which the brake pedal 11 is manipulated by the driver of the vehicle, that is, the degree of depression of the brake pedal 11 (which will also be referred to as a pedal stroke S below) and outputs a brake manipulated variable representing the pedal stroke S. The pedal stroke S is an output from the brake pedal 11 (i.e., the brake actuating member) when manipulated and indicates a desired degree of braking force exerted on the vehicle as a function of the degree of manipulation of the brake pedal 11. The depression of the brake pedal 11 causes a master piston (not shown) installed in the master cylinder 13 to be depressed, thereby developing the same levels of pressure (which will also be referred to as a master cylinder pressure below) in a primary chamber and a secondary chamber defined by the master piston within the master cylinder 13. The master cylinder pressure is transmitted to the wheel cylinders 14, 15, 34, and 35 through the brake pressure control actuator 50.

The brake pressure control actuator 50 includes a first hydraulic circuit 50a and a second hydraulic circuit 50b and is made as a unit by assembling various parts in an aluminum block (not shown). The first hydraulic circuit 50a is a rear hydraulic circuit working to control the brake fluid to be applied to the rear right wheel RR and the rear left wheel RL. The second hydraulic circuit 50b is a front hydraulic circuit working to control the brake fluid to be applied to the front left wheel FL and the front right wheel FR.

The first hydraulic circuit 50a and the second hydraulic circuit 50b are identical in structure with each other. For the brevity of disclosure, the following discussion will refer only to the first hydraulic circuit 50a below.

The first hydraulic circuit 50a is equipped with a main hydraulic line A (also called a main hydraulic path below) through which the pressure in the master cylinder 13 (which will also be referred to as M/C pressure below) is transmitted to the wheel cylinder 14 for the rear left wheel RL and the wheel cylinder 15 for the rear right wheel RR to produce wheel cylinder pressures (which will also be referred to as W/C pressures below) which create the braking force. The wheel cylinder pressure, as referred to herein, is developed in each of the wheel cylinders 14, 15, 34, and 35 as a function of the M/C pressure.

The main hydraulic line A has disposed therein a first differential pressure control valve 16 which is operable in either of two modes: an open mode and a pressure differential mode to control a pressure difference between a first hydraulic line that is an upstream path leading to the master cylinder 13 and a second hydraulic line that is a downstream path leading to the wheel cylinders 14 and 15. Specifically, the first differential pressure control valve 16 is equipped with a solenoid coil. When the solenoid installed in the first differential pressure control valve 16 is deenergized by the ECU 70, the first differential pressure control valve 16 is placed in the open mode. Alternatively, when the solenoid installed in the first differential pressure control valve 16 is energized by the ECU 70, the first differential pressure control valve 16 is placed in the pressure differential mode to create the pressure difference between the first hydraulic line and the second hydraulic line. The valve position of the first pressure differential control valve 16 changes so as to increase the pressure difference with an increase in electric current supplied to the solenoid of the first differential pressure control valve 16.

In the pressure differential mode, the first differential pressure control valve 16 permits the brake fluid to flow from the wheel cylinders 14 and 15 to the master cylinder 13 only when the pressure of the brake fluid on the side of the wheel cylinders 14 and 15 is higher than the master cylinder pressure by a given level or more. This keeps the pressure in the wheel cylinders 14 and 15 from exceeding a level which is higher than the master cylinder pressure by the given level. The check valve 16a is arranged in parallel to the first differential pressure control valve 16.

The main hydraulic line A is equipped with two branch lines: a hydraulic line A1 and a hydraulic line A2 which extend downstream of the first differential pressure control valve 16 to the wheel cylinders 14 and 15, respectively. The hydraulic line A1 is equipped with a first pressure-increasing valve 17 to control a rise in pressure of the brake fluid supplied to the wheel cylinder 14. Similarly, the hydraulic line A2 is equipped with a second pressure-increasing valve 18 to control a rise in pressure of the brake fluid supplied to the wheel cylinder 15.

Each of the first and second pressure-increasing valves 17 and 18 is implemented by a normally-open two-position valve which is opened or closed by the brake ECU 70 to control increasing of the braking hydraulic pressure (i.e., the pressure of the brake fluid applied to the wheel cylinder 14 or 15). Specifically, when the solenoid coil installed in the pressure-increasing valve 17 is deenergized, the first pressure-increasing valve 17 is opened. Alternatively, when the solenoid coil is energized, the first pressure-increasing valve 17 is closed. The same is true for the second pressure-increasing valve 18.

The brake pressure control actuator 50 also includes a hydraulic line B which extends as a pressure-reducing path between a junction of the first pressure-increasing valve 17 and the wheel cylinder 14 and a pressure control reservoir 20 and between a junction of the second pressure-increasing valve 18 and the wheel cylinder 15 and the pressure control reservoir 20. The hydraulic line B has installed therein first and second pressure-reducing valves 21 and 22 which are each implemented by a normally closed two-position solenoid valve to control decreasing of the braking hydraulic pressure (i.e., the pressure of the brake fluid applied to the wheel cylinder 14 or 15). Specifically, each of the first and second pressure-reducing valves 21 and 22 is equipped with a solenoid coil. When the solenoid coils are deenergized, the first and second pressure-reducing valves 21 and 22 are closed. When the solenoid coils are energized, the first and second pressure-reducing valves 21 and 22 are opened.

The brake pressure control actuator 50 also includes a hydraulic line C which extends as a recirculating path between the pressure control reservoir 20 and the hydraulic line A (i.e., the main hydraulic line). The hydraulic line C is equipped with a self-priming gear pump 19 which is driven by an electric motor 60 to suck the brake fluid from the pressure control reservoir 20 and feed it to the master cylinder 13 or the wheel cylinders 14 and 15.

The brake pressure control actuator 50 also includes a hydraulic line D which extends as a sub-hydraulic line between the pressure control reservoir 20 and the master cylinder 13. The gear pump 19 works to suck the brake fluid from the master cylinder 13 through the hydraulic line D, the pressure control reservoir 20, and the hydraulic line C and output it to a required one of the wheel cylinders 14 and 15 through the hydraulic line A to increase the W/C pressure of a target one of the wheels.

The second hydraulic circuit 50b is, as already described, substantially identical in structure with the first hydraulic circuit 50a. Specifically, the second hydraulic circuit 50b is equipped with a second differential pressure control valve 36, a check valve 36a, pressure-increasing valves 37 and 38, first and second pressure-reducing valves 41 and 42, a pump 39, a pressure control reservoir 40, and hydraulic lines E, F, G, and H. The differential pressure control valve 36 corresponds to the differential pressure control valve 16. The pressure-increasing valves 37 and 38 correspond to the pressure-increasing valves 17 and 18. The pressure-reducing valves 41 and 42 correspond to the pressure-reducing valves 21 and 22. The pressure control reservoir 40 corresponds to the pressure control reservoir 20. The pump 39 corresponds to the pump 19. The hydraulic lines E, F, G, and H correspond to the hydraulic lines A, B, C, and D. When it is required to exert a higher braking force on the front wheels than on the rear wheels of the vehicle, the second hydraulic circuit 50b serving as the front hydraulic circuit to control the brake fluid to be applied to the front wheel cylinders 34 and 35 may be designed to has a capacity greater than that of the first hydraulic circuit 50a serving as the rear hydraulic circuit to control the brake fluid to be applied to the rear wheel cylinders 14 and 15.

The brake device 1 is, as described above, equipped with the brake ECU 70. The brake ECU 70 serves as a controller and is implemented by a typical microcomputer made up of a CPU, a ROM, a RAM, an I/O device, etc. The brake ECU 70 executes various operations, as instructed by programs stored in the ROM, to control the motion of the vehicle selectively in different types of braking control modes.

Specifically, the brake ECU 70 monitors outputs of the stroke sensor 12 and the wheel cylinder pressure sensor 80 and selectively executes the braking control modes. For instance, the brake ECU 70 analyzes the output from the stroke sensor 12 (i.e., the brake manipulated variable) to determine the pedal stroke S and then controls the operations of the parts of the brake pressure control actuator 50 to create a degree of braking force as a function of the pedal stroke S. Specifically, the brake ECU 70 calculates a controlled variable for a target one of the wheels, that is, a target W/C pressure to be developed in a corresponding one of the wheel cylinders 14, 15, 35, or 34 as a function of the pedal stroke S and then controls the amounts of electric current supplied to the valves 16 to 18, 21, 22, 36 to 38, 41, and 42 and the motor 60 which drives the pumps 19 and 39 to achieve the target W/C pressure.

The brake device 1 of this embodiment is engineered as a so-called full load assist brake system made up only of the master cylinder 13 with no servo unit and the brake pressure control actuator 50. This type of brake system usually has a shortfall of the W/C pressure developed only by the operation of the brake pedal 11 and thus drives the pumps 19 and 39 to assist in compensating for the shortfall of the W/C pressure over a full range of the braking operation of the brake device 1. The shortfall of the W/C pressure is given by a difference between the M/C pressure, measured by the output from the M/C pressure sensor 80, and a target level of the W/C pressure required to produce a desired degree of braking force as a function of the pedal stroke S. The ECU 70 thus outputs pressure-difference control signals to the differential pressure control valves 16 and 36 to develop the pressure differences and also drives the motor 60 to actuate the pumps 19 and 39 for compensating for the shortfall of the W/C pressure to create the desired degree of braking force. Specifically, each of the pumps 19 and 39 works to discharge the brake fluid to a portion of a corresponding one of the main hydraulic lines A and E between a corresponding one of the differential pressure control valves 16 and 36 and the wheel cylinders 14 and 15 or 34 and 35 to elevate the W/C pressure when the pressure difference is being developed by the differential pressure control valve 16 or 36.

When it is required to execute cooperative braking control with the regenerative braking, the brake device 1 may be engineered to have a dead zone in the master cylinder 13 which does not produce the M/C pressure until the deceleration of the vehicle, as developed by the regenerative braking, reaches a given value (e.g., 0.2 G) even when the brake pedal 11 is depressed. In this case, a required degree of braking force corresponding to the pedal stroke S is given to include a degree of braking force developed by the regenerative braking.

Next, how to determine various sorts of braking characteristics which are references based on which the brake ECU 70 performs the braking control will be described below. The braking characteristics are stored in the RAM of the ECU 70.

First, the concept of establishing the braking characteristics in the brake device 1 will be discussed below.

The brake device 1 of this embodiment is, like in the conventional braking system, designed to determine the speed of the motor 60 based on a relation between the W/C pressure (i.e., the controlled pressure of the brake fluid) and the flow rate of the brake fluid discharged from the pumps 19 and 39.

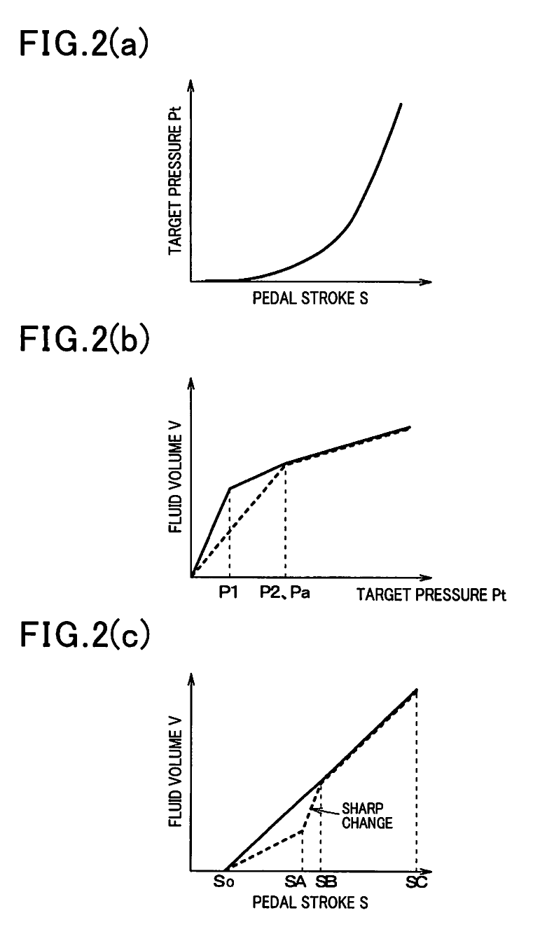

The pressure-to-braking relation demonstrated in FIG. 2(a) in which the target pressure Pt [MPa] of the controlled pressure (i.e., the W/C pressure) of the brake fluid rises gradually with an increase in the pedal stroke S [m] is a desired braking characteristic in the brake device 1. The rate of rise in the target pressure Pt is selected so as to increase with an increase in the pedal stroke S.

The volume-to-pressure relation between the target pressure Pt of the controlled pressure and the volume V[m³] of brake fluid required by a selected one(s) of the wheel cylinders 14, 15, 34, and 35 (i.e., brake calipers of the vehicle) to achieve the target pressure Pt of the wheel cylinder pressure, as indicated by a broken line in FIG. 2(b), depends upon design specifications of the wheel cylinders 14, 15, 34, and 35. Specifically, the volume V of the brake fluid increases at a first rate until the target pressure Pt reaches a given level Pa. When the target pressure Pt exceeds the given level Pa, the volume V of the brake fluid increases at a second rate smaller than the first rate.

From the relations in FIGS. 2(a) and 2(b), a characteristic, as indicated by a broken line in FIG. 2(c), is derived which represents a volume-to-braking relation of the volume V of the brake fluid to the pedal stroke S. The characteristic in FIG. 2(c) depends directly on the relations in FIGS. 2(a) and 2(b) and may be determined simply as representing the relation of the volume V of the brake fluid to the pedal stroke S. The relation indicated by the broken line in FIG. 2(c) has a range in which the volume V of the brake fluid changes sharply in response to an increase in the pedal stroke S. How to define a portion of the braking characteristic before such a range appears is substantially the same as that in the conventional braking systems.

However, by converting the relation between the pedal stroke S and the volume V of the brake fluid in FIG. 2(c) into the relation between the pedal stroke S and the speed R [rpm] of the motor 60 in the same way as described above based on the relation, as illustrated in FIG. 2(d), between the volume D [m³/sec.] of the brake fluid per unit time and the speed R of the motor 60, we obtain a characteristic, as indicated by a broken line in FIG. 2(e). Specifically, between S₀ to SA of the pedal stroke S in FIG. 2(c), the volume V increases at a first rate (i.e., a lower rate), so that the motor speed R is kept at RA. Subsequently, between SA and SB of the pedal stroke S, the volume V increases greatly at a second rate (i.e., a higher rate), so that the motor speed R is kept at RB (>RA). Finally, between SB and SC of the pedal stroke S, the volume V increases gradually again at a third rate (i.e., a lower rate), so that the motor speed R is kept at RC between RA and RB.

The motor speed R, as described above, increases sharply between SA and SB of the pedal stroke S. This causes, as indicated by a broken line in FIG. 2(f), the controlled pressure P (i.e., the W/C pressure) of the brake fluid to have a portion changing greatly due to the pressure loss, as described above, depending on the motor speed R and the hysteresis of the first and second differential pressure control valves 16 and 36, so that the controlled pressure P does not follow the desired braking characteristic indicated by a solid line in FIG. 2(f) which is the same as in FIG. 2(a). This makes the driver feel uncomfortable.

In order to alleviate the above drawback, the brake device 1 of this embodiment is engineered to reduce the sharp change in motor speed R to correct the characteristic of a change in the volume V of the brake fluid in response to the pedal stroke S in order to achieve a linear change in controlled pressure P of the brake fluid in response to the pedal stroke S.

Specifically, the brake device 1 corrects, as indicated by a solid line in FIG. 2(c), the characteristic of a change in the volume V of the brake fluid so that the volume V increases at a given rate in response to an increase in pedal stroke S, in other words, the volume V changes linearly with a change in pedal stroke S. More specifically, the brake device 1 corrects the characteristic of a change in the volume V of the brake fluid so that the volume V increases in direct proportion to an increase in pedal stroke S. Such correction of the characteristic of a change in the volume V causes the motor speed R, as indicated by a solid line in FIG. 2(e), to be kept at a constant value which depends upon the rate of increase in volume V accompanying an increase in pedal stroke S. This results in, as represented by a solid line in FIG. 2(f), a continuous gradual change in controlled pressure P of the brake fluid in response to a change in pedal stroke S, thereby achieving the braking characteristic in FIG. 2(a).

The braking characteristic of FIG. 2(a) is accomplished by correcting the characteristic of a change in volume V of the brake fluid in response to a change in pedal stroke S, as indicated by the broken line in FIG. 2(c), to derive that, as indicated by the solid line in FIG. 2(c), to change the characteristic of a change in volume V in relation to a change in the target pressure Pt, as indicated by the broken line in FIG. 2(b), into that, as indicated by the solid line in FIG. 2(b). Based on this concept, the brake device 1 is designed, unlike the conventional braking systems, to create the characteristic of the relation of the volume V of the brake fluid to the target pressure Pt, as indicated by the solid line in FIG. 2(b), and the characteristic of the relation of the volume V of the brake fluid to the pedal stroke S, as indicated by the solid line in FIG. 2(c).

The brake ECU 70 works as a relation determiner which stores in the RAM the characteristics of FIGS. 2(b), 2(c), and 2(d) in the form of a map and/or an arithmetic expression in order to realize the relation of the target pressure Pt to the pedal stroke Sin FIG. 2(a). The brake ECU 70 may alternatively work as the relation determiner to mathematically calculate or produce the characteristics of FIGS. 2(b), 2(c), and 2(d). Specifically, since the characteristic of the relation between the target pressure Pt and the volume V of the brake fluid, as indicated by the solid line in FIG. 2(b), is derived based on the characteristic of the relation between the volume V of the brake fluid and the pedal stroke S, as indicated by the solid line in FIG. 2(c), the characteristic of FIG. 2(a) which represents an optimum target brake pressure-to-pedal stroke relation is established based on the relations, as indicated by the solid lines in FIGS. 2(b) and 2(c).

When the characteristic indicated by the solid line in FIG. 2(c) in which the volume V of the brake fluid changes in direct proportion to a change in pedal stroke S is developed, the rate of increase in volume V of the brake fluid will be greater, as illustrated in FIG. 2(b), in a lower level range of the target pressure Pt as compared with the relation of the volume V of the brake fluid to the target pressure Pt established according to design specifications of the brake caliper. Additionally, the value of the target pressure Pt at which the rate of increase in the volume V of the brake fluid changes is changed to be lower as compared with the relation of the volume V of the brake fluid to the target pressure Pt established by design specifications of the brake caliper.

Specifically, the volume V of the brake fluid, as can be seen in FIG. 2(b), increases at a first rate until the target pressure Pt reaches a first level P1, at a second rate lower than the first rate until the target pressure Pt reaches a second level (=Pa), and then at a third rate after the target pressure Pt exceeds the second level P2. The first rate is greater than both the second rate and the rate of increase in volume V until the target pressure Pt reaches the given level Pa in the characteristic, as indicated by the broken line in FIG. 2(b), established by the design specifications of the brake caliper. The second rate is greater than the third rate in FIG. 2(b), but may alternatively be selected to be substantially identical with the third rate. The second rate is also smaller than the rate of increase in volume V until the target pressure Pt reaches the given level Pa (=P2) in the characteristic established by the design specifications of the brake caliper.

The maps or arithmetic expressions representing the above characteristics are stored in the RAM (i.e., a storage device) of the brake ECU 70. The brake ECU 70 works as a parameter determiner to determine parameters required to control the braking of the vehicle using the maps or arithmetic expressions in the way, as described below. For the brevity of explanation, the following discussion will ignore the master cylinder pressure developed in relation to the pedal stroke S.

The brake ECU 70 first works as the target pressure determiner to determine the target pressure Pt of the brake fluid as a function of the pedal stroke S, as measured by the stroke sensor 12 when the brake pedal 11 is operated by the driver, using the characteristic, as illustrated in FIG. 2(a). Specifically, the brake ECU 70 sets the target pressure Pt as a function of the pedal stroke S indicating an output of the brake pedal 11 (i.e., the degree of depression of the brake pedal 11) by look-up using the map or according to a mathematical equation representing the relation between the target pressure Pt and the pedal stroke S in FIG. 2(a).

Next, the brake ECU 70 works as a fluid volume determiner to determine the volume V of the brake fluid as a function of the target pressure Pt using the characteristic in FIG. 2(b). Specifically, the brake ECU 70 sets the volume V of the brake fluid as a function of the target pressure Pt by look-up using the map or according to a mathematical equation representing the relation between the volume V of the brake fluid and the target pressure Pt FIG. 2(b). The brake ECU 70 then works as a target speed determiner to determine a target speed of the motor 60 (i.e., the motor speed R) based on a difference between the most recently determined value of the volume V, as determined in this operation cycle, and a previous value of the volume V which has been derived a given time period earlier for achieving the volume of the brake fluid required to achieve the target pressure Pt.

Specifically, the brake ECU 70 performs the above operations in a cycle of control at a given time interval. If the current control cycle is defined as the n^{th} cycle, the volume of the brake fluid required to achieve the current level of the target pressure Pt is defined as volume V(n), and the volume of the brake fluid required to achieve the value of the target pressure Pt, as determined i control cycles earlier, is defined as volume V(n−1), a target speed R(n) of the motor 60 required in the current control cycle is given by

Motor Speed R(n)={volume V(n)−volume V(n−1)}×A+B

where A and B are coefficients depending upon design specifications of the brake device 1. Note that the volume V(n−1) required i control cycles earlier may be derived based on the design specifications. If the control cycle is 6 ms, and i control cycles are 20 control cycles, the volume V(n−1) is the volume of the brake fluid determined 120 ms before.

In the above way, the motor speed R (i.e., a required speed of the motor 60) required to achieve the volume V of the brake fluid is derived. The volume V in the characteristic indicated by the solid line in FIG. 2(b) is, as described above, corrected so that it increases at a given rate in response to a change in pedal stroke S in the characteristic, as demonstrated in FIG. 2(c). This eliminates the sharp change in motor speed R in response to a change in pedal stroke S, as illustrated in FIG. 2(e), so that the motor speed R is kept constant.

After the motor speed R (i.e., a targets speed of the motor 60) is determined, the brake ECU 70 actuates the motor 60 at the motor speed R to drive the pump 19 and/or the pump 39 to achieve the target pressure Pt of the brake fluid to apply the braking force on the wheel(s) of the vehicle as a function of the output of the brake actuating member (i.e., the brake pedal 11).

The actual controlled pressure P of the brake fluid in the wheel cylinders 14, 15, 34, and/or 35 increases gradually, as illustrated in FIG. 2(a), with an increase in the pedal stroke S. The rate of increase in the actual controlled pressure P, as described above, increases with an increase in the pedal stroke S.

In other words, the brake ECU 70 works to increase the controlled pressure P of the brake fluid gradually without changing sharply in response to an increase in the pedal stroke S. This achieves the degree of braking according to the intention of the driver without changing the deceleration of the vehicle undesirably.

### MODIFICATIONS

While the present invention has been disclosed in terms of the preferred embodiment in order to facilitate better understanding thereof, it should be appreciated that the invention can be embodied in various ways without departing from the principle of the invention.

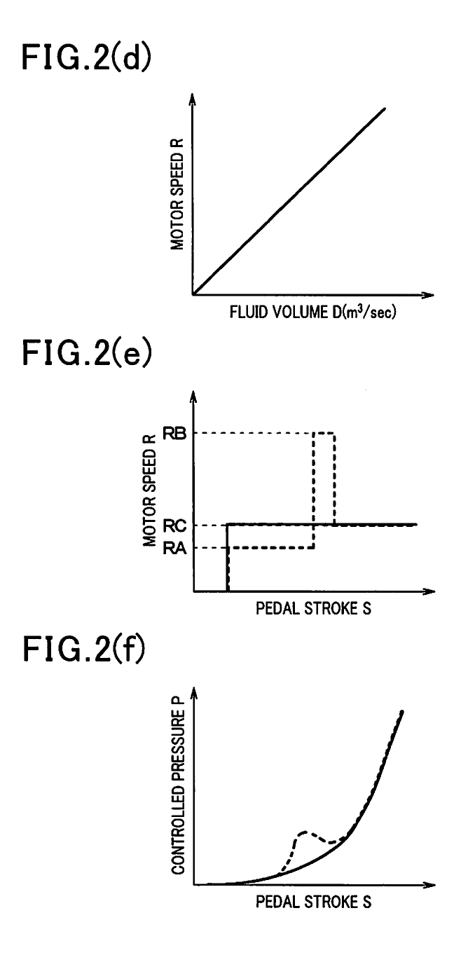

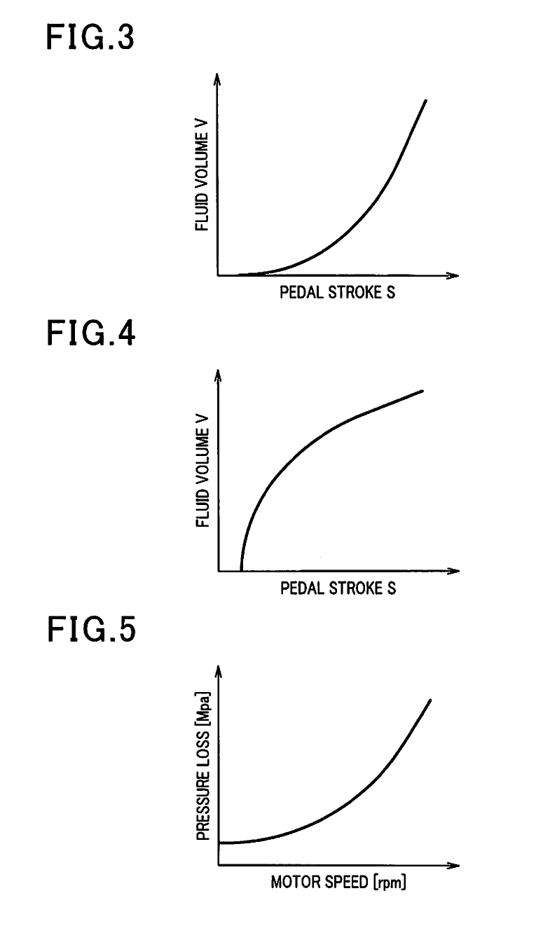

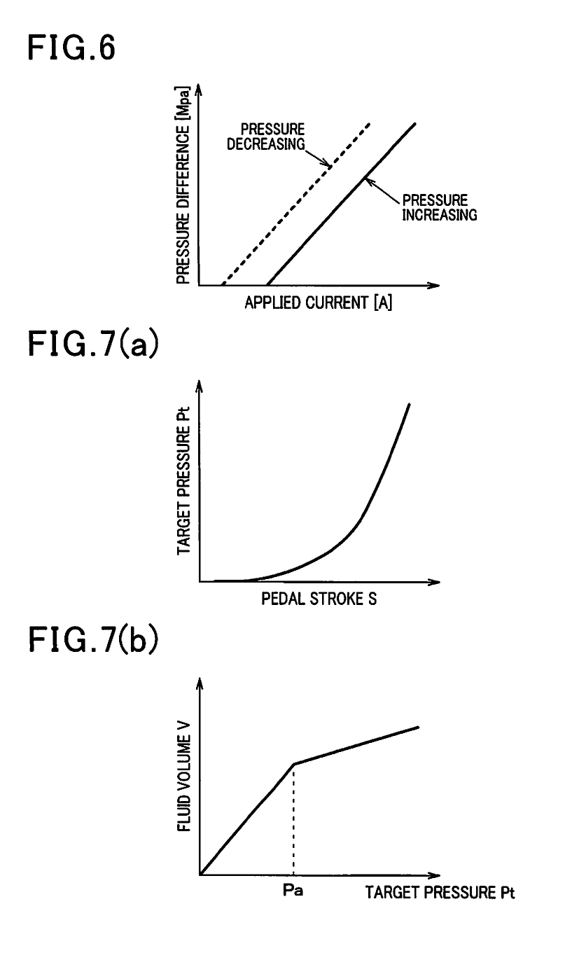

The volume V of the brake fluid is, as already described in FIG. 2(c), set as increasing continuously at a constant rate with an increase in the pedal stroke S, however, may be determined, as illustrated in FIG. 3, so as to rise at a rate increasing with an increase in pedal stroke S. The volume V of the brake fluid may alternatively be determined, as illustrated in FIG. 4, so as to rise at a rate decreasing with an increase in pedal stroke S.

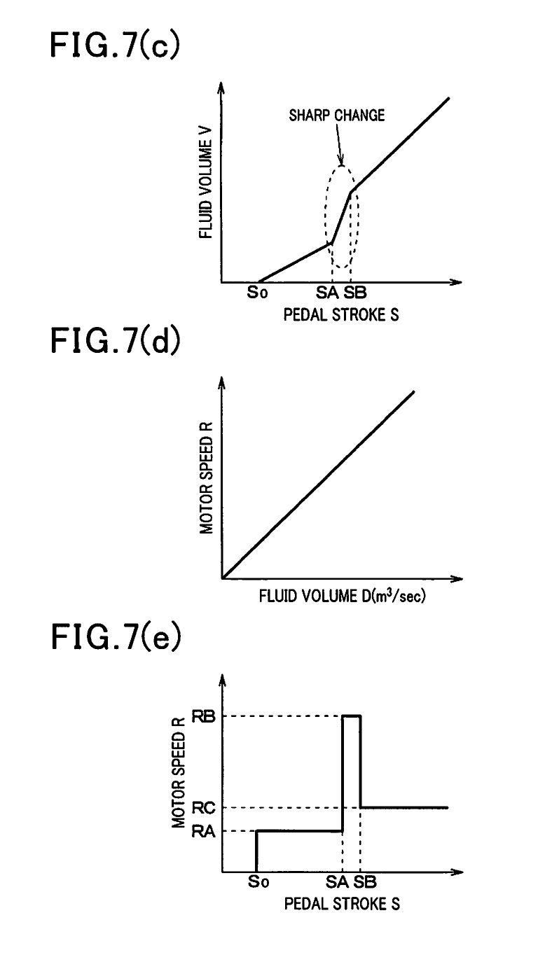

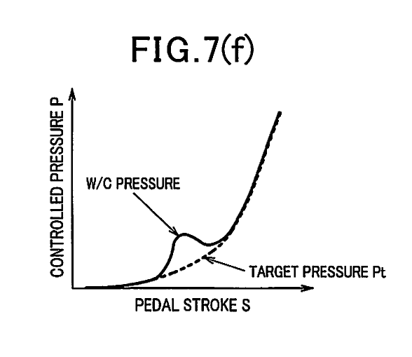

The continuous change in volume V of the brake fluid in response to a change in pedal stroke S means that the rate of rise in volume V of the brake fluid accompanying an increase in pedal stroke S is constant, increases, or decreases gradually (i.e., at a constant or variable rate) without changing from increasing to decreasing or vice versa. This is because the rate of rise in volume V of the brake fluid changing from increasing to decreasing or vice versa will result in a dead zone where the pressure difference, as developed by each of the first and second differential pressure control valves 16 and 36, remains unchanged due to the hysteresis, as demonstrated in FIG. 6, between the increasing and decreasing of the pressure difference regardless of a change in amount of current supplied to the first and second differential pressure control valves 16 and 36.

The brake device 1 is, as described above, used with a so-called full load assist brake system made up only of the master cylinder 13 with no servo unit and the brake pressure control actuator 50, but may be employed with another type of brake systems for vehicles.

For instance, the brake device 1 may be used with brake-by-wire systems which detects the stroke of the brake pedal using a sensor and electrically controls the electric motor of the pump and electromagnetic valves to produce a degree of braking force as a function of the stroke of the brake pedal. Specifically, the brake-by-wire system has a brake pedal side and a hydraulic system which are separate from each other. The driver's effort on the brake pedal is inputted to a brake simulator. The W/C pressure for each wheel is developed by operating the pump. The electromagnetic valves are actuated to bring the W/C pressure into agreement with a target level required by the stroke of the brake pedal. When it is required to create the braking force as a function of the stroke of the brake pedal, the brake-by-wire system may control the speed of the motor in the way, as described in the above embodiment, to actuate the pump. The brake device 1 may also be used with typical brake systems for vehicles which are equipped with a servo unit.

The brake device 1, as described above, uses the stroke of the brake pedal 1 as the output therefrom which represents the amount by which the brake actuating member is manipulated for calculating the target speed of the motor 60. The brake actuating member does not necessarily need to be the brake pedal 11, but may be implemented by a hand-operated brake lever. The output from the brake actuating member (i.e., the brake manipulated variable) does not also necessarily need to be the stroke of the brake pedal 11, but may be a parameter such as a driver's effort on the brake pedal 11 or the level of the pressure in the master cylinder 13 which is developed as a function of the output from the brake actuating member.

What is claimed is:

1. A brake device for a vehicle comprising:
a brake manipulated variable determiner which determines a brake manipulated variable representing a degree to which a brake actuating member is manipulated by an operator of a vehicle;
a master cylinder which works to develop a master cylinder pressure of brake fluid as a function of the brake manipulated variable;
a wheel cylinder in which a wheel cylinder pressure of the brake fluid is developed as a function of the master cylinder pressure to create a braking force exerted on a wheel of the vehicle;
a differential pressure control valve which is disposed in a main hydraulic path extending between the master cylinder and the wheel cylinder and works to create a pressure difference of the brake fluid between the master cylinder pressure and the wheel cylinder pressure;
a pump which works to discharge the brake fluid to a portion of the main hydraulic path between the differential pressure control valve and the wheel cylinder to elevate the wheel cylinder pressure;
a motor which drives the pump; and
a controller which outputs a pressure-difference control signal to place the differential pressure control valve in a pressure-differential mode to develop said pressure difference, the controller also actuating the motor to drive the pump to elevate the wheel cylinder pressure to create the braking force as a function of the brake manipulated variable, the controller including a relation determiner, a target pressure determiner, a fluid volume determiner, and a target speed determiner, the relation determiner working to provide a pressure-to-braking relation between a target pressure of the wheel cylinder pressure and the brake manipulated variable and a volume-to-pressure relation between the target pressure of the wheel cylinder pressure and a volume of the brake fluid required by the wheel cylinder to achieve the target pressure of the wheel cylinder pressure, the pressure-to-braking relation representing the target pressure of the wheel cylinder pressure which raises at a given rate which increases with an increase in the brake manipulated variable, the volume-to-pressure relation being derived based on a volume-to-braking relation between the volume of the brake fluid and the brake manipulated variable, the volume-to-braking relation representing the volume of the brake fluid which increases continuously with an increase in the brake manipulated variable, the target pressure determiner working to determine a target pressure of the wheel cylinder pressure as a function of the brake manipulated variable, as determined by the brake manipulated variable determiner, using the pressure-to-braking relation, the fluid volume determiner working to determine a target volume of the brake fluid as a function of the target pressure, as determined by the target pressure determiner, using the volume-to-pressure relation, the target speed determiner working to determine a target speed of the motor required to achieve the target volume of the brake fluid, the controller actuating the motor at the target speed to achieve the target pressure of the wheel cylinder pressure.

2. A brake device as set forth in claim 1, wherein the volume-to-braking relation represents the volume of the brake fluid which increases at a constant rate with the increase in the brake manipulated variable.

3. A brake device as set forth in claim 1, wherein the volume-to-braking relation represents the volume of the brake fluid which increases at a rate which increases gradually with the increase in the brake manipulated variable.

4. A brake device as set forth in claim 1, wherein the volume-to-braking relation represents the volume of the brake fluid which increases at a rate which decreases gradually with the increase in the brake manipulated variable.

5. A brake device as set forth in claim 1, wherein the volume-to-pressure relation represents the volume of the brake fluid which increases at a first rate until the target pressure reaches a first level, at a second rate lower than the first rate until the target pressure reaches a second level higher than the first level, and then at a third rate after the target pressure exceeds the second level, and wherein the third rate is less than or equal to the second rate.

6. A brake device as set forth in claim 1, wherein the controller has each of the pressure-to-braking relation, the volume-to-pressure relation, and the volume-to-braking relation in the form of one of a map and an arithmetic expression.
